(19) United States
(12) Patent Application Publication
(10) Pub. No.: US 2008/0203817 A1
(43) Pub. Date: Aug. 28, 2008

(54) Power architecture for battery powered remote devices

(76) Inventors: Shiguo Luo, Austin, TX (US); John J. Breen, Harker Heights, TX (US); Mohammed K. Hijazi, Austin, TX (US)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 11/709,675

(22) Filed: Feb. 22, 2007

(51) Int. Cl. H02J 7/00; G06F 3/02

(52) U.S. Cl. 307/64; 345/169

(57) ABSTRACT

Systems and methods that may be employed to provide a high-reliability power architecture for an information handling system and a physically separable (i.e., detachable) remote system. The information handling system may be, for example, a portable information handling system such as a notebook computer. The remote system may be, for example, a battery-powered input or input/output device such as a wireless keyboard configured to wirelessly communicate input/output information with the information handling system, and that is also configured to be physically and electrically coupled to the information handling system to allow a flow of current to be provided from circuitry of the information handling system to circuitry of the remote system. The power architecture may be implemented using multiple (e.g., two) Uninterrupted Power System (UPS) buses.

### FIELD OF THE INVENTION

This invention relates generally to battery systems, and more particularly to battery systems for information handling systems.

### BACKGROUND OF THE INVENTION

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Examples of portable information handling systems include notebook computers. These portable electronic devices are typically powered by battery systems such as lithium ion (“Li-ion”) or nickel metal hydride (“NiMH”) battery packs including one or more rechargeable batteries. High performance notebook computer systems present an increasingly complex challenge for power architecture design. For example, some current high end notebook computers are provided with a wireless keyboard to allow a user to enter data from the keyboard without requiring a wired connection between the keyboard and the notebook computer system chassis. In such a system, a main battery (e.g., of 4S3P configuration) may be provided within the notebook computer chassis to support the notebook computer system power requirements, while the wireless keyboard may be provided with another separate battery (e.g., of 1S4P or 1S2P configuration) to support the wireless keyboard. Reliability of such a power architecture for supplying both main notebook computer system and the wireless keyboard system is of concern during power line or battery outages.

### SUMMARY OF THE INVENTION

Disclosed herein are systems and methods that may be advantageously implemented to provide a high-reliability power architecture for an information handling system and a physically separable (i.e., detachable) remote system. The information handling system may be, for example, a portable information handling system such as a notebook computer. The remote system may be, for example, a battery-powered input or input/output device such as a wireless keyboard configured to wirelessly communicate input/output information with the information handling system, and that is also configured to be physically and electrically coupled to the information handling system to allow a flow of current to be provided from circuitry of the information handling system to circuitry of the remote system. The power architecture may be implemented in one embodiment using multiple (e.g., two) power buses, e.g., Uninterrupted Power System (UPS) buses.

In one embodiment disclosed herein, an information handling system may be configured as a system that is provided with a first UPS bus that is capable of support by power from multiple possible primary power sources, e.g., power from a battery charger output (e.g., AC adapter output) and/or power from a main battery pack of the information handling system. In this embodiment, a remote system for the information handling system may be provided with a second UPS bus that is also configured to be capable of support by power from multiple possible sources, for example, from secondary power sources of the information handling system such as two separate and different voltage regulators of the information handling system (e.g., a main system voltage regulator and an auxiliary voltage regulator) and a battery of the remote system that is separate from the main system battery. For example, when the remote system is detached and physically separated from the information handling system, circuitry of the remote system may be provided with power solely from an integrated battery or battery pack within the remote system via the second UPS bus. However, when the remote system is docked with the information handling system so that circuitry of the remote system is electrically coupled to circuitry of the information handling system, the remote system may be then powered via the second UPS bus by one or more of multiple possible power sources including, but not limited to, two separate and different voltage regulators of the information handling system and/or by the battery pack of the remote system.

Advantageously, the disclosed systems and methods may be implemented to provide a reliable and guaranteed power supply to key components of the remote system such as a blue tooth (BT) module, even under a circumstance such as when one of the voltage regulators of the main system is not operating at the same time that the battery of the remote system (e.g., integrated remote system battery pack) is discharged.

In one respect, disclosed herein is a power architecture, including and information handling system and a wireless keyboard system. The information handling system may include a main system load and battery and charging circuitry, the battery and charging circuitry including at least two first separate power sources including at least one main system battery, at least two second separate power sources and a main system power bus coupled to receive current from the at least two first separate power sources, the main system power bus being coupled to provide current to the main system load and to the at least two second separate power sources. The wireless keyboard system may include a remote system battery, a remote system load, and a remote system power bus, the wireless keyboard system being physically separable from the information handling system, and the wireless keyboard system being configured to be removably coupled to the battery and charging circuitry of the information handling system to allow the remote system power bus to receive current from the at least two second separate power sources of the battery and charging circuitry of the information handling system. The wireless keyboard system may further include a remote system power bus configured to supply current to the remote system load, the remote system power bus being coupled to receive current from the remote system battery, and the remote system power bus being further configured to receive current from the at least two second separate power sources of the battery and charging circuitry of the information handling system when the wireless keyboard system is coupled to the information handling system.

In another respect, disclosed herein is a power architecture, including an information handling system including battery and charging circuitry, the battery and charging circuitry including at least two separate power sources; and a remote system including a remote system battery and a remote system load, the remote system being physically separable from the information handling system, and the remote system being configured to be removably coupled to the battery and charging circuitry of the information handling system to receive current from the at least two separate power sources. The remote system may further include a remote system power bus configured to supply current to the remote system load, the remote system power bus being coupled to receive current from the remote system battery, and the remote system power bus being further configured to receive current from the at least two separate power sources of the battery and charging circuitry of the information handling system when the remote system is coupled to the information handling system.

In yet another respect, disclosed herein is a method for powering a system load of a remote system, including: providing an information handling system including battery and charging circuitry, the battery and charging circuitry including at least two separate power sources; providing a remote system including a remote system battery, a remote system load, and a remote system power bus coupled to receive current from the remote system battery and to supply current to the remote system load, wherein the remote system is physically separable from the information handling system, and wherein the remote system is configured to be removably coupled to the battery and charging circuitry of the information handling system to allow the remote system power bus to receive current from the at least two separate power sources; supplying current to the remote system bus from at least one of the remote system battery, a first one of the at least two separate power sources of the battery and charging circuitry, a second one of the at least two power sources of the battery and charging circuitry, or a combination thereof; and supplying current from the remote system bus to the remote system load.

### BRIEF DESCRIPTION OF THE DRAWINGS

FIG. 1 is a block diagram of an information handling system coupled to a wireless keyboard system according to one embodiment of the disclosed systems and methods.

FIG. 2 is a simplified perspective view of an information handling system and physically separable wireless keyboard system according to one embodiment of the disclosed systems and methods.

FIG. 3 is a flow chart of methodology that may be implemented according to one embodiment of the disclosed systems and methods.

FIG. 4 is a simplified block diagram of a smart battery pack according to one embodiment of the disclosed systems and methods.

### DESCRIPTION OF ILLUSTRATIVE EMBODIMENTS

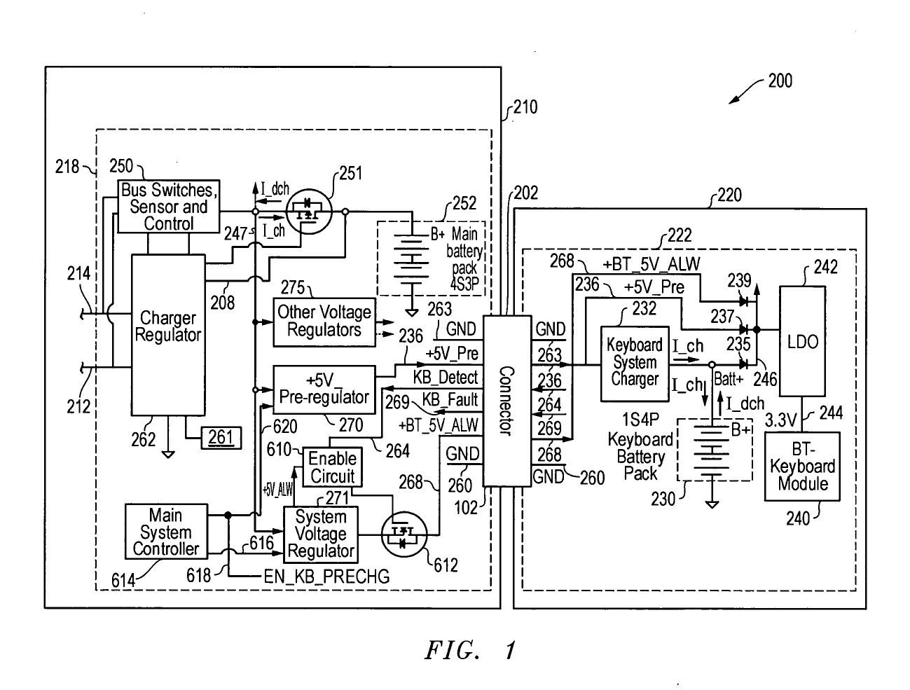

FIG. 1 shows one exemplary embodiment of a power architecture 200 of the disclosed systems and methods in which a physically remote system in the form in the form of a wireless keyboard system 220 (e.g., with QWERTY or any other keyboard configuration suitable for entry of data) having keyboard subsystem circuitry 222 as it may be removably coupled via connector 202 to battery and charging circuitry 218 of an information handling system 210, e.g., portable information handling system such as notebook computer system. As described elsewhere herein, wireless keyboard system 220 may be connected to information handling system 210 (e.g., notebook computer) 210 for receiving power from battery and charging circuitry 218 for purposes of powering remote system circuitry of the wireless keyboard (e.g., Bluetooth keyboard module 240 and/or other remote system load) and/or charging of a remote system battery in the form of wireless keyboard battery 230 (e.g., smart battery or dumb battery). Connector 202 may be any connection apparatus suitable for temporarily coupling wireless keyboard system 220 to battery and charging circuitry 218 including, but not limited to, device to device (cableless) pin and connector mechanical interconnects, cable interconnects, etc.

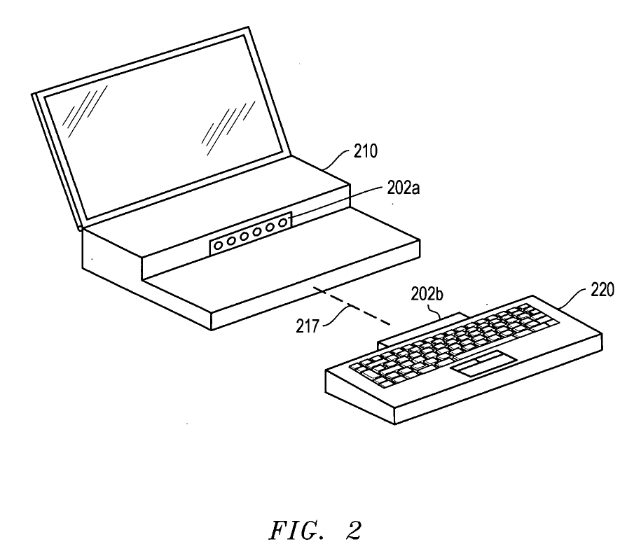

FIG. 2 shows an embodiment in which wireless keyboard system 220 is physically separable from an information handling system 210 (in the form of a notebook computer) at connector 202 (e.g., including connector halves 202a and 202b) so that wireless keyboard system 220 is capable of remote operation while physically separated from information handling system 210 via wireless communication link 217 with information handling system 210, as shown in FIG. 2.

In the embodiment of FIG. 1, wireless keyboard system 220 may be configured as a stand-alone wireless keyboard that is capable of short range wireless communication with information handling system 210 when connected or disconnected from information handling system 210. Wireless keyboard system 220 may communicate wirelessly with information handling system 210 using any suitable wireless medium including, but not limited to, radio frequency (e.g., Bluetooth) medium, optical (e.g., infrared) medium, etc. Although a wireless keyboard system is described and illustrated with respect to FIG. 1, it will be understood that other physically separable remote devices may be similarly configured with a battery system in a manner for interfacing with battery and charging circuitry of an information handling system as described elsewhere herein. Examples of other such remote devices include, but are not limited to, input and input/output (I/O) devices such as a wireless game port, wireless storage module, etc.

Still referring to FIG. 1, keyboard subsystem circuitry 222 of wireless keyboard includes a keyboard battery pack 230 (e.g., smart battery pack system capable of sensing and providing voltage information or other information about its own operating condition) for powering other circuitry of wireless keyboard system 220 that in this embodiment includes Bluetooth-keyboard controller module 240. In the illustrated embodiment of FIG. 1, keyboard battery pack 230 includes a 1S4P 4-cell battery cell configuration that has an average operating voltage of 3.6 volts, and a maximum voltage of 4.3 volts, although any other suitable battery cell and/or voltage configuration is possible. As shown, keyboard battery pack 230 is coupled via remote system UPS bus 246 to supply current to low drop out regulator (LDO) 242, which in turn supplies regulated current 244 of fixed voltage (3.3 volts) to Bluetooth-keyboard controller module 240. It will be understood that the illustrated battery cell configuration is exemplary only and that other battery cell configurations may be employed, e.g., a 1S2P battery cell configuration, etc. Moreover, it will be understood that in other embodiments the presence of LDO may not be required, and/or that any other suitable combination of additional or alternative circuitry components may be present to couple a remote system UPS bus to a remote system load such as Bluetooth-keyboard controller module 240.

In one embodiment, keyboard subsystem circuitry may include an optional communication interface to communicate control signals and to enable communication between keyboard battery pack 230 and keyboard controller module 240 e.g., to enable keyboard battery pack 230 to provide information related to charge state and operating condition of keyboard battery pack 230 to Bluetooth-keyboard controller module 240. Such a communication interface may be provided in the form of a digital communication interface, e.g., System Management Bus (SMBus), I2C, Single Wire, etc. Further information on such a configuration may be found in U.S. patent application Ser. No. 11/527,126 filed Sep. 26, 2006, and entitled “Battery Systems For Information Handling Systems” by Shiguo Luo et al., which is incorporated herein by reference in its entirety.

In FIG. 1, keyboard battery pack 230 is shown coupled to remote system UPS bus 246 and to a remote system charger present in the form of keyboard system charger 232. In this configuration, keyboard system charger 232 provides charge current I_ch for charging keyboard battery pack 230, and/or to power remote system load circuitry (e.g., LDO 242, keyboard module 240, wireless transceiver circuitry, etc.) of wireless keyboard system 220 via remote system UPS bus 246 as shown. When wireless keyboard system 220 is disconnected from information handling system 210, battery cells of keyboard battery pack 230 provide discharge current I_dch to other circuitry of wireless keyboard system 220 as shown. As represented by diode symbol 235, the current path between keyboard system charger 232 and keyboard battery pack 230 is one-way or unidirectional toward remote system UPS bus 246.

In the illustrated embodiment of FIG. 1, battery and charging circuitry 218 of FIG. 1 includes a main system battery pack 252 in a 4S3P 12-cell configuration that has a an average operating voltage of 14.8 volts, and a maximum voltage of 17.2 volts, although any other suitable battery cell and/or voltage configuration is possible. In one embodiment, main system battery pack 252 may be a smart battery pack system. A main charger regulator and controller 262 is coupled to receive current from current supply terminals 212, 214 (e.g., alternating current, or direct current from an AC adapter), and to produce DC power as current 208 that is provided to main system UPS bus 247 as shown. As shown, main system UPS bus 247 is coupled to distribute power from main charger regulator and controller 262 to main system battery pack 252, and to secondary power sources of information handling system 210 provided in the form of multiple voltage regulators (e.g., pre-regulator 270, system voltage regulator 271, one or more optional other regulators 275). UPS bus 247 is also coupled by various voltage regulators (e.g., regulators 270, 271 and/or 275) and control switches which interface with and distribute power of appropriate voltage to one or more system loads (such as CPU processor, display, chipsets, I/O devices, Bluetooth transceiver, etc.) of information handling system 210. Although one exemplary embodiment is illustrated in FIG. 1, it will be understood that a main system power bus may be coupled to any suitable combination and number of primary and secondary power sources that is suitable for implementing the disclosed methods and systems described herein.

As shown, main system UPS bus 247 is also coupled to provide discharge current (L_dch) from a separate primary power source of information handling system 210 (main system battery pack 252) to secondary power sources that in this exemplary embodiment include multiple voltage regulators 270, 271 and/or 275 to distribute power to system load of information handling system 210. Auxiliary battery charger controller 261 may also be present within battery and charging circuitry 218 for purposes that include controlling operation of main charger regulator and controller 262 and controlling flow and characteristics of current provided from main charger regulator and controller 262 to main system UPS bus 247 based on operational status of main charger regulator and controller 262 and main system battery pack 252. Auxiliary charger controller 261 may be an analog controller with some digital functionality, and may be configured to communicate with a microcontroller of a battery management unit (BMU) (not shown) of main system battery pack 252 through system BIOS of information handling system 210.

Multiple voltage regulators (e.g., pre-regulator 270 and system voltage regulator 271) of battery and charging circuitry 218 are shown in FIG. 1 as they may be temporarily coupled via connector 202 to supply power to remote system UPS bus 246. In particular, pre-regulator 270 is shown temporarily coupled to provide current 236 (e.g., of +5V_Pre), and system voltage regulator 271 is shown coupled to provide current 268 (e.g., +BT_{—}5V_ALW). In one embodiment, system voltage regulator 271 may be a voltage regulator present in information handling system 210 that regulates voltage for other circuitry of information handling system 210. In this regard, system voltage regulator 271 may be configured in one exemplary embodiment to be activated only intermittently, e.g., system voltage regulator 271 may be activated and supply current while information handling system is in a fully “active” state, but may be inactive or supplying no current when information handling system 210 is in a power saving “suspend” or partially-suspended state. Other voltage regulators 275 may be optionally present as shown, e.g., for purposes of regulating and supplying current to other systems of information handling system 210.

In the illustrated exemplary embodiment, other pins shown present at connector 202 include ground pins 260 and 263, keyboard connection detection pin 264 for providing signal to information handling system 210 indicating connection of wireless keyboard system 220, and keyboard fault pin 269. As shown, an enable circuit 610 is provided that senses connection of wireless keyboard system 220 to information handling system 210 and via keyboard connection control signal provided from keyboard connection detection pin 264, and that selectably enables flow of current 268 from system voltage regulator 271 when keyboard connection is sensed using MOSFET power switch 612. Diodes 237 and 239 may be present in keyboard subsystem 222 to limit current 236 and 268 to one-way or unidirectional toward remote system UPS bus 246, which in turn supplies current to LDO 242 as shown. It will be understood that the illustrated combination of pins and other circuitry of FIG. 1 is exemplary only, and that any other circuitry combination may be employed that is suitable for sensing remote system connection and/or that is suitable for controlling flow of current from a main system to a remote system.

Still referring to FIG. 1, operation of pre-regulator 270 may be controlled based on operating state of system voltage regulator 271. For example, in the illustrated embodiment, main system controller 614 may control operating state of system voltage regulator 271 using control signal 616, and may control operation of pre-regulator 270 using control signal 620. In such an exemplary embodiment, main system controller 614 may activate pre-regulator 270 using control signal 620 to make current 236 available to remote system UPS bus 246 when main system controller 614 detects that system voltage regulator 271 is in an inactive state (e.g., during “suspend” state of information handling system 210 or is otherwise inactive or off for any reason). As shown, operation of pre-regulator 270 may also be optionally controlled by a separate control signal 618 (e.g., EN_KB_PRECHG received from user, CPU or other processor such as GPIO notebook computer embedded keyboard controller) to activate pre-regulator 270 to make current 236 available to remote system UPS bus 246 at any other time. Examples of such other times include anytime that voltage of current supplied by pre-regulator 270 is detected to be greater than voltage of current supplied by system voltage regulator 271. It will be understood that the preceding description of the control of regulators 270 and 271 is exemplary only, and that any other control methodology may be implemented that is suitable for arbitrating or otherwise controlling operation of two or more secondary power sources to supply uninterrupted current from a main system bus to a remote system power bus under a variety of multiple operating conditions of the main system and/or a connected remote system.

In FIG. 1, main system battery pack 252 is also coupled to provide discharge current (I_dch) to UPS bus 247 for supply of voltage regulators 270, 271 and/or 275. A power selector 251 controlled by main charger regulator and controller 262 is shown present in the main system UPS bus 247 for blocking direct application of voltage from current supply terminals 212, 214 to battery terminals of main battery pack 252 when such voltage is present at current supply terminals 212, 214 (e.g., AC adapter is present and operating), but to instantly allow main battery pack 252 to support main system UPS bus 247 when voltage is absent at current supply terminals 212, 214 (e.g., AC adapter is not present or not operating). Also shown present are bus switches, sensor and control 250 that are coupled to main charger regulator and controller 262, adapter input rail 212, 214, and main system UPS bus 247. Once again, it will be understood that the particular illustrated circuitry details of FIG. 1 are exemplary only, and that other circuit configurations are possible.

In the exemplary embodiment of FIG. 1, a high-reliability power architecture 200 is provided for information handling system 210 and physically separable (i.e., detachable) wireless keyboard system 220 that relies on two UPS buses 246 and 247. In this exemplary architecture, UPS bus 247 of information handling system 210 is capable of support by power from multiple possible sources, i.e., main charger regulator and controller 262 and main battery pack 252. UPS bus 246 of wireless keyboard system 220 is also capable of support by power from multiple possible sources, i.e., from wireless keyboard battery 230 and in this example two separate and different voltage regulators of information handling system 210 that include system voltage regulator 271 and an auxiliary voltage regulator in the form of pre-regulator 270. The multiple power sources available to each of buses 246 and 247 may be implemented in any manner suitable for increasing reliability of power supplied to information handling system 210 and/or physically separable wireless keyboard system 220.

For example, during one exemplary embodiment of operation for power architecture 200, UPS bus 247 of information handling system 210 may be supported with power either from main charger regulator and controller 262 (i.e., voltage is present at current supply terminals 212, 214) or from main battery pack 252 (i.e., when voltage is absent at current supply terminals 212, 214). When wireless keyboard system 220 is detached and physically separated from information handling system 210, UPS bus 246 of wireless keyboard system 220 is supported with power from wireless keyboard battery 230. However, when wireless keyboard system 220 is docked with information handling system 210 and coupled via connector 202 to battery and charging circuitry 218 of information handling system 210, UPS bus 246 may be supported by any of the three available power sources of this exemplary embodiment. For example, UPS bus 246 may be supported by wireless keyboard battery 230 if no power is available from battery and charging circuitry 218 (e.g., when voltage is absent at current supply terminals 212, 214) or may be supported by either current 268 (i.e., +BT_{—}5V_ALW) of system voltage regulator 271 or current 236 (i.e., +5V_Pre) of pre-regulator 270 (e.g., when voltage is present at current supply terminals 212, 214).

Using the above-described exemplary power architecture of FIG. 1, power supply for Bluetooth-keyboard controller module 240 of wireless keyboard system 220 may be maintained as long as power is available from at least one of wireless keyboard battery 230 or from main charger regulator and controller 262. For example, even in a situation where wireless keyboard battery 230 is discharged and one of regulators 270 or 271 is not functioning, Bluetooth wireless communication between wireless keyboard system 220 and information handling system 210 may be supported by power supplied to Bluetooth-keyboard controller module 240 as long the other one of regulators 270 or 271 remains functioning. Such may be the case, for example, when wireless keyboard battery 230 is discharged and system voltage regulator 271 is in inactive state (e.g., in suspend mode), but pre-regulator 270 is available to continue providing power via current 236 to UPS bus 246 via connector 202. In another possible example, pre-regulator 270 may be alternatively employed as a dedicated and/or default source of power for UPS bus 246 when wireless keyboard system 220 is coupled to information handling system 210, and system voltage regulator 271 may be implemented as a non-dedicated and/or emergency backup source of power for UPS bus 246 that may be controlled to supply current 268 in the event that pre-regulator 270 fails for any reason. In yet another possible example, voltage of current available from pre-regulator 270 and system voltage regulator 271 may both be monitored and the regulator having available current with the highest voltage at any given time may be selected to provide power for UPS bus 246. Thus it will be understood that the disclosed high-reliability power architecture may be implemented in a variety of different ways to achieve increased reliability and durability of power supplied to a remote system such as wireless keyboard system 220.

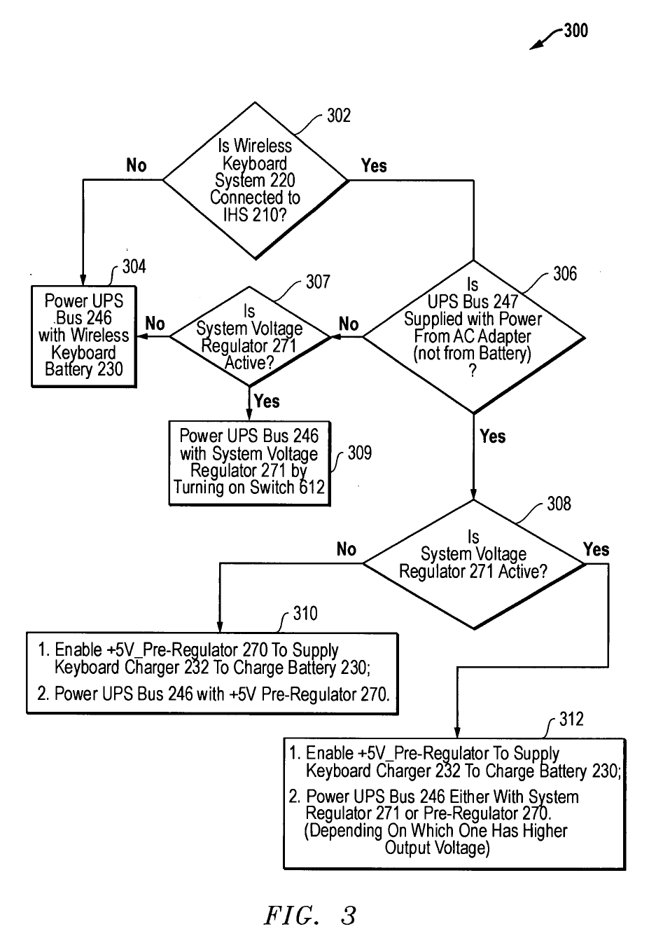

FIG. 3 is a flow chart showing one exemplary embodiment of methodology 300 for operating power architecture 200 of FIG. 2, it being understood that other methodologies may be employed, including those with fewer, additional and/or alternative steps. Methodology 300 starts in step 302 in which it is determined whether wireless keyboard system 220 is connected via connector 202 to battery and charging circuitry 218 of information handling system (IHS) 210. If not connected, then UPS bus 246 is powered by wireless keyboard battery 230 as shown in step 304. However, if wireless keyboard system 220 is connected via connector 202 to battery and charging circuitry 218, then it is next determined in step 306 if UPS bus 247 is supplied with power from an AC adapter or from main system battery pack 252.

If in step 306 UPS bus 247 is found to be supplied with power from an AC adapter, then it is next determined in step 307 if system voltage regulator 271 is active (i.e., IHS 210 is not shutdown) or not active (i.e., IHS 210 is shutdown). If it is determined in step 307 that system voltage regulator 271 is active, then UPS bus 246 is powered by system voltage regulator 271 (e.g., by closing power switch 612) as shown in step 309. However, if it is determined in step 307 that system voltage regulator 271 is not active, then UPS bus 246 is powered by wireless keyboard battery 230 as shown in step 304.

If in step 306 UPS bus 247 is found not to be supplied with power from main system battery pack 252, then it is next determined in step 308 if system voltage regulator 271 is active (iLe., IHS 210 is not shutdown) or not active (i.e., IHS 210 is shutdown). If it is determined in step 308 that system voltage regulator 271 is active, then two actions are taken in step 312: 1) pre-regulator 270 is enabled to supply keyboard system charger 232 to charge keyboard battery pack 230, and 2) UPS bus 246 is powered by either system regulator 271 or pre-regulator 270, depending on which of these two regulators has the higher output voltage (i.e., the regulator with the highest output voltage is selected to power UPS bus 246 in step 312). However, if it is determined in step 308 that system voltage regulator 271 is not active, then two actions are taken in step 310: 1) pre-regulator 270 is enabled to supply keyboard system charger 232 to charge keyboard battery pack 230, and 2) pre-regulator 270 is also enabled to power UPS bus 246.

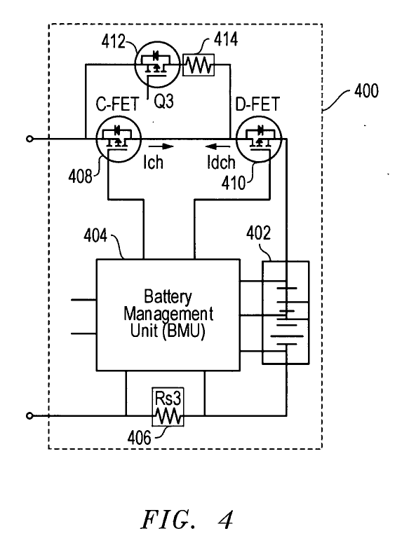

FIG. 4 shows one exemplary embodiment of a smart battery pack 400 that may be optionally implemented as a main system battery pack (e.g., main system battery pack 252) and/or remote system battery pack (e.g., keyboard battery pack 230). As shown, smart battery pack 400 includes battery cell/s 402, e.g., any type of rechargeable battery cell/s or combination thereof including, but are not limited to, Li-ion battery cells, NiMH battery cells, nickel cadmium (NiCd) battery cells, lithium-polymer (Li-polymer) battery cells, etc. Also present is battery management unit (“BMU”) 404 that is responsible for monitoring battery system operation and for controlling battery system charge and discharge components in the form of charge FET 408 and discharge FET 410. A current sense resistor 406 is present in the battery pack circuitry to allow BMU 404 to monitor charging current to the battery cell/s. During normal battery pack operations both charge and discharge FET switching elements 408 and 410 are placed in the closed state by BMU 404, which monitors voltage of battery cell/s 402. If BMU 404 detects a battery over-voltage condition, BMU 404 opens the charge FET switching element 408 to prevent further charging of the battery cell/s until the over-voltage condition is no longer present. Similarly, if BMU 404 detects a battery under-voltage (or over-discharge) condition, BMU 404 opens the discharge FET switching element 410 to prevent further discharging of the battery cell/s until the under-voltage condition is no longer present.

Also shown present in FIG. 4 is pre-charge circuitry that is present to pre-charge battery cell/s 402 when battery cell/s 402 have been discharged to below a predetermined low voltage level and are not ready to receive their full charging current. As shown, this pre-charge circuitry includes MOSFET 412 (Q3) used as a switch, and a resistor 414 (Rs3) to limit the level of the pre-charge current to a much lower current value than the normal charging current provided by main charger regulator and controller 262 or keyboard system charger 232, as may be the case. During pre-charging mode, BMU turns on MOSFET switch 412 and maintains charge FET switching element 408 in open state to limit the charging current provided to battery cell/s 402 to the lower pre-charge current level until voltage of battery cell/s 402 reaches the predetermined low voltage level. When voltage of battery cell/s 402 reaches the predetermined low voltage level, BMU 404 turns off MOSFET 412 and closes charge FET switching element 408 to allow the full charging current to be provided to battery cell/s 402. It will be understood that the battery configuration of FIG. 4 is exemplary only, and that any other battery configuration may be employed that is suitable for implementation with the systems and methods disclosed herein.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

While the invention may be adaptable to various modifications and alternative forms, specific embodiments have been shown by way of example and described herein. However, it should be understood that the invention is not intended to be limited to the particular forms disclosed. Rather, the invention is to cover all modifications, equivalents, and alternatives falling within the spirit and scope of the invention as defined by the appended claims. Moreover, the different aspects of the disclosed systems and methods may be utilized in various combinations and/or independently. Thus the invention is not limited to only those combinations shown herein, but rather may include other combinations.

What is claimed is:

1. A power architecture, comprising:
an information handling system comprising a main system load and battery and charging circuitry, said battery and charging circuitry including at least two first separate power sources comprising at least one main system battery, at least two second separate power sources and a main system power bus coupled to receive current from said at least two first separate power sources, said main system power bus being coupled to provide current to said main system load and to said at least two second separate power sources;
a wireless keyboard system comprising a remote system battery, a remote system load, and a remote system power bus, said wireless keyboard system being physically separable from said information handling system, and said wireless keyboard system being configured to be removably coupled to said battery and charging circuitry of said information handling system to allow said remote system power bus to receive current from said at least two second separate power sources of said battery and charging circuitry of said information handling system;
wherein said wireless keyboard system further comprises a remote system power bus configured to supply current to said remote system load, said remote system power bus being coupled to receive current from said remote system battery, and said remote system power bus being further configured to receive current from said at least two second separate power sources of said battery and charging circuitry of said information handling system when said wireless keyboard system is coupled to said information handling system.

2. The power architecture of claim 1, wherein at least one of said at least two second power sources comprises a dedicated power source for said remote system power bus; and wherein at least one other of said at least two second power sources comprises a non-dedicated power source for said remote system power bus.

3. The power architecture of claim 2, wherein at least one of said at least two second power sources comprises a voltage regulator dedicated for supplying current to said remote system power bus; and wherein at least one other of said at least two second power sources comprises a voltage regulator for supplying current to said remote system power bus and other circuitry of said information handling system.

4. The power architecture of claim 1, wherein said at least two first separate power sources of said information handling system comprise a charger regulator and a main battery pack of said information handling system.

5. The power architecture of claim 1, wherein said wireless keyboard system further comprises a remote system battery charger coupled to said remote system battery, said remote system battery charger being configured to receive current from said at least two second separate power sources of said battery and charging circuitry of said information handling system when said wireless system is coupled to said information handling system.

6. The power architecture of claim 1, wherein said information handling system comprises a notebook computer.

7. A power architecture, comprising:
an information handling system comprising battery and charging circuitry, said battery and charging circuitry including at least two separate power sources;
a remote system comprising a remote system battery and a remote system load, said remote system being physically separable from said information handling system, and said remote system being configured to be removably coupled to said battery and charging circuitry of said information handling system to receive current from said at least two separate power sources;
wherein said remote system further comprises a remote system power bus configured to supply current to said remote system load, said remote system power bus being coupled to receive current from said remote system battery, and said remote system power bus being further configured to receive current from said at least two separate power sources of said battery and charging circuitry of said information handling system when said remote system is coupled to said information handling system.

8. The power architecture of claim 7, wherein each of said at least two separate power sources of said battery and charging circuitry of said information handling system comprise secondary power sources of said battery and charging circuitry.

9. The power architecture of claim 8, wherein each of said at least two separate power sources of said battery and charging circuitry of said information handling system comprise a voltage regulator of said battery and charging circuitry.

10. The power architecture of claim 8, wherein said information handling system further comprises a main system power bus and at least two separate primary power sources, said main system power bus being coupled to receive current from said at least two separate primary power sources; and wherein said main system power bus is coupled to provide current to power said at least two separate secondary power sources of said battery and charging circuitry of said information handling system.

11. The power architecture of claim 10, wherein said at least two separate primary power sources of said information handling system comprise a charger regulator and a main battery pack of said information handling system.

12. The power architecture of claim 7, wherein said remote system further comprises a remote system battery charger coupled to said remote system battery, said remote system battery charger being configured to receive current from said at least two separate secondary power sources of said battery and charging circuitry of said information handling system when said remote system is coupled to said information handling system.

13. The power architecture of claim 7, wherein said remote system comprises a wireless keyboard; and wherein said information handling system comprises a notebook computer.

14. A method for powering a system load of a remote system, comprising:
providing an information handling system comprising battery and charging circuitry, said battery and charging circuitry including at least two separate power sources;
providing a remote system comprising a remote system battery, a remote system load, and a remote system power bus coupled to receive current from said remote system battery and to supply current to said remote system load, wherein said remote system is physically separable from said information handling system, and wherein said remote system is configured to be removably coupled to said battery and charging circuitry of said information handling system to allow said remote system power bus to receive current from said at least two separate power sources;
supplying current to said remote system bus from at least one of said remote system battery, a first one of said at least two separate power sources of said battery and charging circuitry, a second one of said at least two power sources of said battery and charging circuitry, or a combination thereof; and
supplying current from said remote system bus to said remote system load.

15. The method of claim 14, wherein each of said at least two separate power sources comprise secondary power sources of said battery and charging circuitry; wherein said battery and charging circuitry further comprises a main system power bus and at least two separate primary power sources; and wherein said method further comprises supplying current to said main system power bus from said at least two separate primary power sources, and providing current from said main system power bus to power said at least two separate secondary power sources.

16. The method of claim 15, wherein said at least two separate primary power sources of said information handling system comprise a charger regulator and a main battery pack of said information handling system; and wherein said at least two secondary power sources each comprise voltage regulators of said information handling system.

17. The method of claim 14, wherein said remote system further comprises a remote system battery charger coupled to said remote system battery; and wherein said method further comprises supplying current to said remote system battery charger from said at least two separate secondary power sources of said battery and charging circuitry of said information handling system when said remote system is coupled to said information handling system.

18. The method of claim 14, wherein said method further comprises supplying current from at least one of said at least two secondary power sources to said remote system power bus for powering said remote system load when said remote system is coupled to said information handling system; and wherein said method further comprises supplying current to said remote system power bus for powering said remote system load from said remote system battery when said remote system is not coupled to said information handling system.

19. The method of claim 14, wherein at least one of said at least two secondary power sources comprises a dedicated power source configured for supplying current to said remote system power bus; wherein at least one other of said at least two secondary power sources comprises a non-dedicated power source configured for supplying current to said remote system power bus and other circuitry of said information handling system; and wherein said method further comprises supplying current to said remote system power bus from said dedicated secondary power source to said remote system power bus when said non-dedicated secondary power source is inactive.

20. The method of claim 14, wherein said remote system comprises a wireless keyboard system.

21. The method of claim 20, wherein said information handling system comprises a notebook computer.
